(19) United States
(12) Patent Application Publication
(10) Pub. No.: US 2026/0269635 A1
(43) Pub. Date: Sep. 10, 2026

(54) METHOD AND APPARATUS FOR DISTRIBUTING POWER COMMANDS

(71) Applicant: HANWHA SOLUTIONS CORPORATION, Seoul (KR)

(72) Inventor: Kang Mun LEE, Seoul (KR)

(21) Appl. No.: 19/551,774

(22) Filed: Feb. 27, 2026

(30) Foreign Application Priority Data
Mar. 10, 2025 (KR) 10-2025-0030677

(51) Int. Cl. H02J 7/56; H02J 3/32; H02J 3/38; H02J 7/35; H02J 7/44; H02J 7/82; H02J 7/90; H02J 13/13; H02J 101/24; H02J 107/10

(52) U.S. Cl. CPC H02J 7/56; H02J 3/32; H02J 3/381; H02J 7/35; H02J 7/44; H02J 7/82; H02J 7/933; H02J 13/1321; H02J 2101/24; H02J 2107/10

(57) ABSTRACT

Provided are a method and apparatus for distributing power commands. The method of distributing power commands may include determining whether a certain condition regarding a level of state of charge (SOC) imbalance is satisfied based on SOC values obtained from a plurality of energy storage systems, and in response to the certain condition being satisfied, distributing a total power command value to the plurality of energy storage systems in order of SOC values, and distributing the total power command value based on charge and discharge limit values, and in response to the certain condition not being satisfied, distributing the total power command value to the plurality of energy storage systems in order of charge and discharge limit values, and distributing the total power command value based on an SOC ratio and charge and discharge limit values.

### CROSS-REFERENCE TO RELATED APPLICATION

This application is based on and claims priority under 35 U.S.C. § 119 to Korean Patent Application No. 10-2025-0030677, filed on Mar. 10, 2025, in the Korean Intellectual Property Office, the disclosure of which is incorporated by reference herein in its entirety.

### BACKGROUND

1. Field

The disclosure relates to a method and apparatus for distributing power commands.
2. Description of the Related Art

As the distribution of power supply systems using photovoltaic power generation has recently expanded, in order to implement efficient operation of power supply systems, technology for storing power generated by photovoltaic power generation and supplying the power to a load when necessary by combining energy storage systems (ESSs) with the power supply systems has been developed.

However, according to the technology of the related art, state of charge (SOC) values of a plurality of ESSs may differ from each other during a charging and discharging process due to differences in manufacturing, battery characteristics, usage environment, and charging and discharging control methods, and when the same power command is equally distributed in this state, there is a concern that a specific ESS may be excessively charged and discharged, causing problems such as performance degradation of the entire system and shortening of battery life.

Accordingly, there is a need to develop technology capable of resolving SOC imbalance and realizing more stable and efficient power supply by dynamically distributing power commands in consideration of SOC values and charge and discharge limit values of each ESS.

The background art described above is technical information retained by the inventors in order to derive the disclosure or obtained by the inventors in the process of deriving the disclosure, and thus is not necessarily known art disclosed to the general public before the filing of the application.

### SUMMARY

The disclosure provides a method and apparatus for distributing power commands.

Problems to be solved by the disclosure are not limited to the problems mentioned above, and other problems and advantages of the disclosure not mentioned may be understood from the following description and will be more clearly understood by the embodiments of the disclosure. In addition, it will be understood that the problems to be solved by the disclosure and the advantages of the disclosure may be realized by means and combinations thereof indicated in the patent claims.

As technical solutions for achieving the technical problems described above, according to a first aspect of the disclosure, a method of distributing power commands may be provided, the method including determining whether a certain condition regarding a level of state of charge (SOC) imbalance is satisfied based on SOC values obtained from a plurality of energy storage systems, and in response to the certain condition being satisfied, distributing a total power command value to the plurality of energy storage systems in order of SOC values, and distributing the total power command value based on charge and discharge limit values, and in response to the certain condition not being satisfied, distributing the total power command value to the plurality of energy storage systems in order of charge and discharge limit values, and distributing the total power command value based on an SOC ratio and charge and discharge limit values.

According to a second aspect of the disclosure, an apparatus for distributing power commands may be provided, the apparatus including a memory storing at least one program, and a processor operating by executing the at least one program, wherein the processor is configured to determine whether a certain condition regarding a level of state of charge (SOC) imbalance is satisfied based on SOC values obtained from a plurality of energy storage systems, and in response to the certain condition being satisfied, distribute a total power command value to the plurality of energy storage systems in order of SOC values, and distribute the total power command value based on charge and discharge limit values, and in response to the certain condition not being satisfied, distribute the total power command value to the plurality of energy storage systems in order of charge and discharge limit values, and distribute the total power command value based on an SOC ratio and charge and discharge limit values.

According to a third aspect of the disclosure, a computer-readable recording medium having recorded thereon a program for executing the method according to the first aspect of the disclosure on a computer, may be provided.

Other aspects, features, and advantages of the disclosure will become more apparent from the following drawings, claims, and detailed description of the disclosure.

### BRIEF DESCRIPTION OF THE DRAWINGS

The following drawings attached to the specification illustrate one or more embodiments of the disclosure and serve to further understand the technical ideas of the disclosure together with the detailed description to be described below, and thus, the disclosure should not be construed as being limited only to the descriptions illustrated in such drawings. The above and other aspects, features, and advantages of certain embodiments of the disclosure will be more apparent from the following description taken in conjunction with the accompanying drawings, in which:

FIG. 1 is a schematic drawing for explaining a power supply system;

FIG. 2 is an example of a power supply system according to an embodiment;

FIG. 3 is an example of a power supply system according to another embodiment;

FIG. 4 is an example of a power supply system including a plurality of energy storage systems and a power command distribution equipment;

FIG. 5 is an example of an operating method of a power command distribution equipment;

FIG. 6 is a drawing for explaining a process of obtaining data from a plurality of energy storage systems;

FIG. 7 is a drawing for explaining a process of distributing a total power command value to a plurality of energy storage systems when a certain condition is satisfied;

FIG. 8 is a drawing for explaining a process of sequentially distributing a total power command value when a certain condition is satisfied;

FIG. 9 is a drawing for explaining a process of distributing a total power command value to a plurality of energy storage systems when a certain condition is not satisfied;

FIG. 10 is a drawing for explaining a process of sequentially distributing a total power command value when a certain condition is not satisfied;

FIG. 11 is a drawing for explaining a process of repeatedly distributing a total power command value to a plurality of energy storage systems at every preset time period; and

FIG. 12 is a block diagram of a power command distribution equipment.

### DETAILED DESCRIPTION

Effects and features of the disclosure, and methods for achieving them will be clarified with reference to embodiments described below in detail with reference to the accompanying drawings. However, the disclosure is not limited to the embodiments presented below, but may be implemented in various different forms, and should be understood to include all modifications, equivalents, or substitutes which fall within the spirit and technical scope of the disclosure. The embodiments presented below are to make the disclosure complete and are provided to fully inform those of ordinary skill in the art of the scope of the disclosure. In the description of the disclosure, when it is determined that specific explanations of known technologies may obscure the essence of the disclosure, the specific explanations are omitted.

Terms used in the specification are used only to describe specific embodiments and are not intended to limit the disclosure. Unless otherwise defined, all terms used in the specification have the same meaning as generally understood by those of ordinary skill in the art to which the disclosure pertains.

As used in the specification, the singular forms include the plural forms unless the context clearly indicates otherwise. Also, terms “include,” “comprise,” and “have” are intended to specify the presence of features, numbers, steps, operations, components, parts, or combinations thereof described in the specification, and do not preclude the presence or possibility of addition of one or more other features, numbers, steps, operations, components, parts, or combinations thereof.

Moreover, terms including ordinal numbers, such as “first” and “second,” used in the specification, may be used to describe various components, but the components should not be limited by these terms. The terms are used only for the purpose of distinguishing one component from another.

Phrases “in an embodiment,” “according to an embodiment,” “in relation to an embodiment,” and “according to the implementation of an embodiment” used in the specification do not necessarily refer to the same embodiment. Moreover, “embodiments” throughout the specification are an arbitrary distinction to facilitate the explanation of the disclosure, and each embodiment does not need to be mutually exclusive. For example, components mentioned for describing an embodiment may be applied and/or implemented in other embodiments, and may be applied and/or implemented with modifications within the scope of the disclosure.

Some embodiments of the disclosure may be represented by functional block components and various processing steps. Some or all of these functional blocks may be implemented by various numbers of hardware and/or software components which perform specific functions. For example, the functional blocks of the disclosure may be implemented by one or more microprocessors or by circuit components for specific functions.

For example, the functional blocks of the disclosure may be implemented in various programming or scripting languages. The functional blocks may be implemented as algorithms executed on one or more processors. Moreover, the disclosure may employ technologies of the related art for electronic environment settings, signal processing, and/or data processing. Terms “mechanism,” “element,” “means,” and “component” may be used broadly and are not limited to mechanical and physical components. Also, terms “. . . or/er” and “module” refer to a unit which processes at least one function or operation, which may be implemented in hardware or software, or a combination of hardware and software.

Furthermore, connection lines or connection members between components shown in the drawings are merely examples of functional connections and/or physical or circuit connections. In actual apparatuses, connections between components may be represented by various replaceable or additional functional connections, physical connections, or circuit connections.

Also, some components in the drawings may have been somewhat exaggerated in size or proportion. Moreover, components shown in certain drawings may not be shown in other drawings.

The disclosure will be described in detail with reference to the accompanying drawings below.

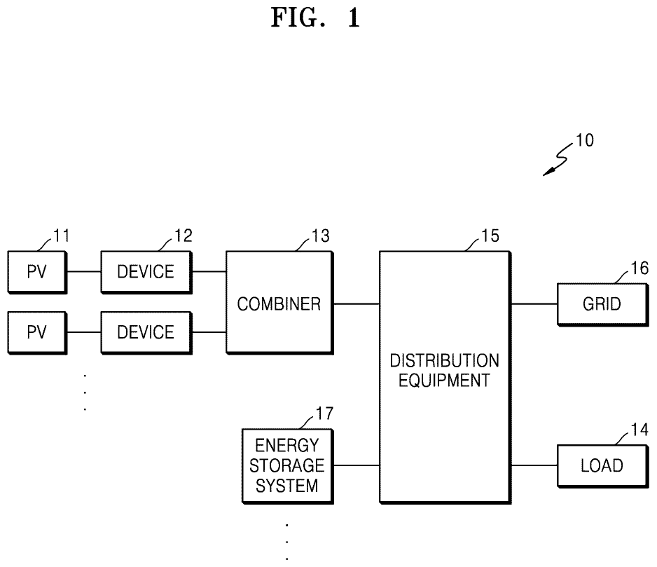

FIG. 1 is a schematic drawing for explaining a power supply system 10.

Referring to FIG. 1, the power supply system 10 may include a photovoltaic module 11, a device 12, a load 14, and/or a distribution equipment 15. The power supply system 10 may be connected to an external power grid 16.

At least one photovoltaic module 11 may be installed on a roof or an exterior wall of a building to generate power. A plurality of photovoltaic modules 11 may be connected to form a photovoltaic module array.

The photovoltaic module 11 may be connected to the device 12. For example, at least one device 12 may be connected to each photovoltaic module 11. As an example, when one device 12 is connected to each photovoltaic module 11, the number of devices 12 constituting the power supply system 10 may be the same as the number of photovoltaic modules 11.

The device 12 may include a power conditioning system or power conversion system (PCS) that converts power generated by the photovoltaic module 11. For example, the device 12 may perform certain conversion on power generated by the photovoltaic module 11 and supply the power to other components (for example, the power grid 16 and/or the load 14) of the power supply system 10.

In some embodiments, the device 12 may include module-level power electronics (MLPE). For example, the device 12 may include an optimizer or a micro inverter (MI).

As an example, when the device 12 is an optimizer, the device 12 may regulate power produced by the photovoltaic module 11 and output the power to an inverter (for example, a string inverter). A current converted (for example, converted from direct current (DC) to alternating current (AC)) by the inverter may be output to the power grid 16 or the load 14.

As another example, when the device 12 is an MI, the device 12 may convert power generated by the photovoltaic module 11 (for example, convert DC to AC). A current converted by the device 12 may be output to the power grid 16 or the load 14.

When necessary, the power supply system 10 may further include a combiner 13. At least some of the devices 12 may be connected to the distribution equipment 15 through the combiner 13. For example, power output from the plurality of devices 12 may be combined into one output in the combiner 13 and supplied to the distribution equipment 15.

Moreover, the device 12 and the distribution equipment 15 may be connected through a power path that does not include the combiner 13, and at least one device 12 may be connected to the distribution equipment 15 through a power path that does not include the combiner 13, and at least one other device 12 may be connected to the distribution equipment 15 through the combiner 13.

The combiner 13 may control voltage, current, and/or power output from the device 12 based on power supply states of the photovoltaic module 11, the device 12, and/or the power grid 16 and may set an operation mode of the combiner 13 to a diagnostic mode or an operational mode.

In some embodiments, the combiner 13 may include an energy management system (EMS) that controls operation of the combiner 13. The EMS may control voltage, current, and/or power supplied to or output from the combiner 13 based on the power supply states of the photovoltaic module 11, the device 12, and/or the power grid 16 and may set the operation mode of the combiner 13 to a diagnostic mode or an operational mode.

The load 14 refers to an object that is installed in an electric consumer such as a house, a commercial facility, or a factory and operates by receiving at least one of energy generated by the photovoltaic module 11, energy stored in an energy storage system (ESS) 17, and/or energy supplied from the power grid 16. For example, when the electric consumer receiving power is a house, the load 14 may include a home appliance such as a washing machine, a refrigerator, or a television (TV).

The power grid 16 may include an infrastructure system for generating, transmitting, and distributing power. For example, the power grid 16 may include an infrastructure system such as a power plant, a substation, and a power line network. In some embodiments, the power grid 16 may transmit electric energy generated at a power plant to the power supply system 10 or may transmit surplus power generated by the power supply system 10 to the outside of the power supply system 10.

For example, commercial power transmitted from the power grid 16 through a power pole may be supplied to a power consumer through a transformer. Moreover, the power supply system 10 may be implemented as an off-grid system that is not connected to the power grid 16.

In some embodiments, the power supply system 10 may further include at least one ESS 17. When necessary, the power supply system 10 may include a plurality of ESSs 17. The ESS 17 may receive and store power generated by the photovoltaic module 11 and/or power transmitted from the power grid 16. The ESS 17 may efficiently supply power by storing power and supplying power to the load 14 when the load 14 requires the power.

The ESS 17 may include a battery that stores power and a power conversion module. The battery may include a battery management system (BMS) that monitors SOC, SOH, voltage, and/or current of the battery, diagnoses the battery, and performs safety functions such as current cutoff.

In some embodiments, the power conversion module may be a PCS that performs conversion between battery-side power and opposite-side power. For example, the PCS may perform conversion between battery-side DC and opposite-side AC. As an example, the PCS may include a bidirectional DC-DC converter connected to the battery to convert voltage, and a bidirectional inverter connecting the DC-DC converter to the exterior of the ESS 17.

In some embodiments, the ESS 17 may further include an EMS that controls operation of the ESS 17. The EMS may control voltage, current, and/or power control supplied to or output from the ESS 17 based on power supply states of the battery and/or the power grid 16 and may set an operation mode of the ESS 17 to a diagnostic mode or an operational mode.

When necessary, an EMS coupled to a certain component of the power supply system 10 may not only control operation of the certain component but may further control operations of other components of the power supply system 10. For example, an EMS coupled to the combiner 13 or an EMS coupled to the ESS 17 may control both operation of the combiner 13 and operation of the ESS 17.

In some embodiments, the distribution equipment 15 may provide electrical connection between components of the power supply system 10 and may control power flow of the power supply system 10. For example, the distribution equipment 15 may electrically connect the photovoltaic module 11 and the load 14 to each other. As an example, the distribution equipment 15 may be connected to the device 12 connected to the photovoltaic module 11 to electrically connect the photovoltaic module 11 and the load 14 to each other. When necessary, the distribution equipment 15 may be further connected to at least one of the ESS 17 and the power grid 16.

For example, the distribution equipment 15 may include a distribution panel that distributes power within the power supply system 10. As an example, the distribution equipment 15 may be a Master Service Panel (MSP) that distributes power generated by the photovoltaic module 11 to the load 14 or the like.

As another example, the distribution equipment 15 may include a main controller that performs power distribution within the power supply system 10 and controls each device 12. As an example, the main controller may include a switch, a circuit breaker, and a controller. The switch, the circuit breaker, and the controller may each be implemented as independent apparatuses, or at least some of the switch, the circuit breaker, and the controller may be included in a single apparatus.

The main controller may include a switch that controls electrical connection between components connected to the main controller, such as the device 12 and the load 14. For example, the main controller may include a relay or a power semiconductor that provides or blocks electrical connection to the device 12 and/or the ESS 17 based on an operation state of each component of the power supply system 10.

The main controller may perform rapid shutdown that stops power generation of the photovoltaic module 11 in an emergency situation such as occurrence of overcurrent in the power supply system 10. To this end, the main controller may include a circuit breaker that blocks connection between the device 12 and the load 14.

The main controller may include a controller that generally controls operation of the main controller. The controller may control operations of other components of the power supply system 10 (for example, the device 12 or the ESS 17) in addition to the main controller.

The controller may control voltage, current, and/or power output from each component or supplied to each component based on power supply states of the photovoltaic module 11, the device 12, the combiner 13, the load 14, the power grid 16, and/or the ESS 17. In some embodiments, the controller may set operation modes of the main controller, the device 12, and/or the ESS 17 to a diagnostic mode or an operational mode.

For example, the controller may control the photovoltaic module 11, the device 12, the combiner 13, and/or the ESS 17 based on the state of the power supply system 10. As an example, the controller may control other components of the power supply system 10 by causing the main controller to communicate with other components (for example, the device 12) of the power supply system 10. Communication between the main controller and other components of the power supply system 10 may be performed using a power line communication (PLC) method, but is not limited thereto.

As an example, the controller may control the device 12 based on a power generation state of the photovoltaic module 11. For example, the main controller may receive a control command from a server that monitors the power generation state of the photovoltaic module 11, and the controller may control the device 12 based on the control command.

The main controller may supply power to at least a part of the load 14 when power supply from the power grid 16 is not smooth (for example, in case of an off-grid situation). For example, when power supply from the power grid 16 is not smooth, the main controller may preferentially supply power generated from the photovoltaic module 11 and/or power stored in the ESS 17 to a backup load that has a relatively high need for stable power supply.

Moreover, the power supply system 10 may further include an auxiliary power generator (for example, a diesel generator) that generates power using a method other than photovoltaic power generation. For example, the auxiliary power generator may be further connected to the distribution equipment 15. When the main controller is unable to respond to the backup load with only the photovoltaic module 11 and the ESS 17 due to environmental factors such as time zone or weather, the main controller may supply power generated by the auxiliary power generator to the backup load.

The controller may be implemented by at least one processor. The processor may process commands of a computer program by performing basic arithmetic, logic, and input/output operations. In this case, the commands may be provided from an internal memory of the main controller or from an external device. In some embodiments, the processor may generally control operations of other components included in the main controller.

Furthermore, the processor may perform at least some of data analysis, processing, and result information generation for performing the operations described above by using at least one of machine learning, a neural network, or a deep learning algorithm as a rule-based or artificial intelligence algorithm. Examples of the neural network may include neural network models based on architectures such as a convolutional neural network (CNN), a deep neural network (DNN), and a recurrent neural network (RNN).

For example, the processor may be implemented as an array of a plurality of logic gates, or may be implemented as a combination of a general-purpose microprocessor and a memory storing a program executable by the microprocessor. For example, the processor may include a general-purpose processor, a central processing unit (CPU), a microprocessor, a digital signal processor (DSP), a controller, a microcontroller, a state machine, and the like.

In some environments, the processor may also include an application-specific integrated circuit (ASIC), a programmable logic device (PLD), a field-programmable gate array (FPGA), and the like. For example, the processor may refer to a combination of processing devices, such as a combination of a DSP and a microprocessor, a combination of a plurality of microprocessors, a combination of one or more microprocessors combined with a DSP core, or a combination of any other such configurations.

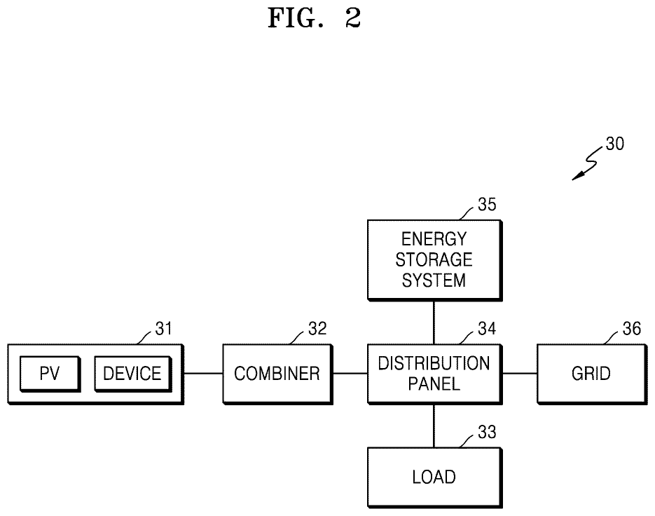

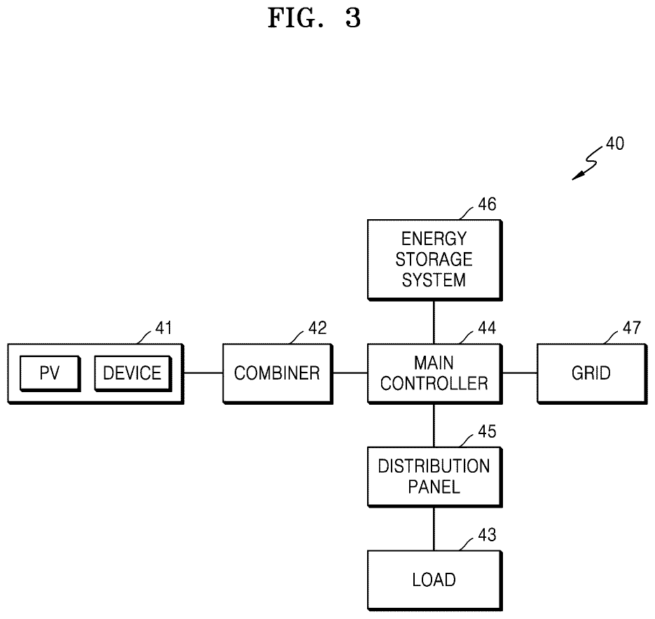

By combining at least some of the components described above, the power supply system 10 may be implemented in various forms. Hereinafter, various embodiments of the power supply system 10 will be described with reference to FIGS. 2 to 3. However, an implementation method of the power supply system 10 is not limited to embodiments to be described below.

FIG. 2 is an example of a power supply system 30 according to an embodiment.

Referring to FIG. 2, the power supply system 30 according to an embodiment may include a photovoltaic generator 31, a combiner 32, a load 33, a distribution panel 34, and an ESS 35. In some embodiments, the power supply system 30 may be connected to an external power grid 36.

In an embodiment, the ESS 35 may be connected to the distribution panel 34 to be charged or discharged. In another embodiment, the ESS 35 may be connected to the combiner 32 to be charged or discharged.

By providing the ESS 35 in the power supply system 30, when the photovoltaic generator 31 alone is unable to respond to the load 33, power stored in the ESS 35 may be used to respond to the load 33. In some embodiments, when power generated by the photovoltaic generator 31 exceeds an amount of power for responding to the load 33, the excess may be stored in the ESS 35. Moreover, when a charge amount of the ESS 35 is less than or equal to a threshold and power generated by the photovoltaic generator 31 does not exceed the amount of power for responding to the load 33, power supplied from the power grid 36 may be charged to the ESS 35.

Accordingly, the power supply system 30 may efficiently supply power to the load 33 by using the ESS 35.

Moreover, the combiner 32 may control voltage, current, and/or power control output from the photovoltaic generator 31 based on power supply states of the photovoltaic generator 31, the load 33, and/or the power grid 36 and may set an operation mode of the combiner 32 to a diagnostic mode or an operational mode.

In some embodiments, the ESS 35 may control voltage, current, and/or power supplied to or output from the ESS 35 based on the power supply states of the photovoltaic generator 31, the load 33, and/or the power grid 36 and may set an operation mode of the ESS 35 to a diagnostic mode or an operational mode.

In an embodiment, the power supply system 30 may further include a sub-panel (not shown) connected to the distribution panel 34. In this case, at least one photovoltaic generator 31 may be connected to the sub-panel through the combiner 32, and at least one other photovoltaic generator 31 may be directly connected to the sub-panel.

In some embodiments, at least one ESS 35 may be connected to the combiner 32, the distribution panel 34, or the sub-panel to be integrated into the power supply system 30.

Moreover, at least one photovoltaic generator 31 and the distribution panel 34 may be connected through a power path that does not include the combiner 32. For example, at least one photovoltaic generator 31 may be connected to the distribution panel 34 through a power path that does not include the combiner 32, and at least one other photovoltaic generator 31 may be connected to the distribution panel 34 through the combiner 32.

In an embodiment, at least one photovoltaic generator 31 may be connected to the sub-panel through the combiner 32, and at least one other photovoltaic generator 31 may be directly connected to the sub-panel.

By providing a sub-panel that provides additional capacity, the power supply system 30 may increase a total amount of power generation from the photovoltaic generator 31 that may be integrated into the power supply system 30.

FIG. 3 is an example of a power supply system 40 according to another embodiment.

Referring to FIG. 3, the power supply system 40 according to an embodiment may include a photovoltaic generator 41, a combiner 42, a load 43, a main controller 44, a distribution panel 45, and an ESS 46. In some embodiments, the power supply system 40 may be connected to an external power grid 47.

Moreover, the main controller 44 illustrated in FIG. 3 may correspond to the main controller described above with reference to FIG. 1.

The combiner 42 may electrically connect at least one photovoltaic generator 41 and the main controller 44 to each other. For example, the combiner 42 may combine power output from the at least one photovoltaic generator 41 into one output and supply the power to the main controller 44.

The main controller 44 may electrically connect the combiner 42, the distribution panel 45, and the power grid 47 to each other. In some embodiments, the main controller 44 may connect the components described above to an auxiliary power source such as the ESS 46 and/or an auxiliary power generator (for example, a diesel generator). For example, the main controller 44 may output power supplied from the combiner 42 to the distribution panel 45, the ESS 46, and/or the power grid 47. Also, the main controller 44 may output power supplied from the power grid 47 to the distribution panel 45 or the ESS 46. In some embodiments, the main controller 44 may output power supplied from the ESS 46 to the distribution panel 45.

The distribution panel 45 may electrically connect the main controller 44 and the at least one load 43 to each other. Accordingly, the power supply system 40 may supply power generated by the photovoltaic generator 41 to the load 43 through the distribution panel 45.

By providing the main controller 44, the power supply system 40 may integrate a plurality of ESSs 46 and/or the auxiliary power generator into the power supply system 40, thereby stably supplying power. In some embodiments, the power supply system 40 may stably supply power to the load 43 such as a backup load even in an off-grid environment where the power supply system 40 does not stably receive power from the power grid 47.

Moreover, the main controller 44 may control voltage, current, and/or power output from each component or supplied to each component based on the states of the photovoltaic generator 41, the load 43, the ESS 46, and/or the power grid 47 and may set operation modes of the main controller 44, the photovoltaic generator 41, and/or the ESS 46 to a diagnostic mode or an operational mode.

In an embodiment, the power supply system 40 may further include a sub-panel (not shown) that is connected to the main controller 44 and distinguished from the distribution panel 45. In this case, at least one backup load having a relatively high need for stable power supply among loads 43 may be connected to the sub-panel, and at least one non-backup load having a relatively low need for stable power supply among the loads 43 may be connected to the distribution panel 45.

The main controller 44 may electrically connect the combiner 42, the distribution panel 45, the ESS 46, the power grid 47, and the sub-panel to each other. The main controller 44 may supply power supplied from the combiner 42, the ESS 46, and/or the power grid 47 to the at least one non-backup load through the distribution panel 45 and to the backup load through the sub-panel.

In some embodiments, in an embodiment, the power supply system 40 may further include the sub-panel that is connected to the main controller 44 and distinguished from the distribution panel 45, and the power grid 47 may be connected to the distribution panel 45 instead of being connected to the main controller 44. That is, the main controller 44 may electrically connect the combiner 42, the distribution panel 45, the ESS 46, and the sub-panel to each other, and the distribution panel 45 may electrically connect the main controller 44, the non-backup load, and the power grid 47 to each other.

For example, the power supply system 40 may be implemented by connecting the main controller 44 that connects the combiner 42 and the ESS 46 to the distribution panel 45 that is pre-installed to connect the at least one load 43 and the power grid 47 to each other.

Accordingly, the power supply system 40 may stably supply power to the load 43 such as a backup load even in an off-grid environment where the power supply system 40 does not stably receive power from the power grid 47.

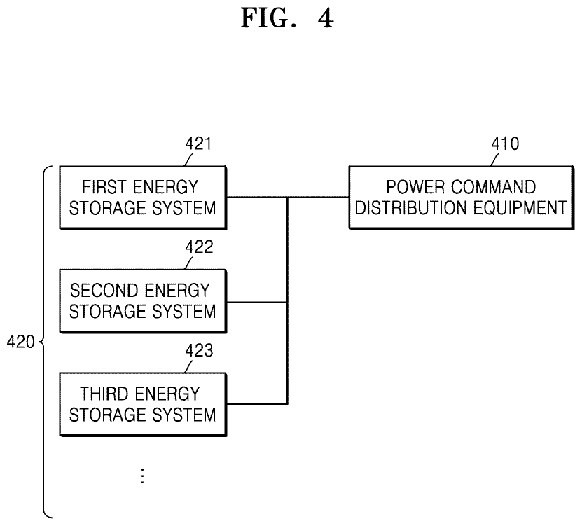

FIG. 4 is an example of a power supply system including a plurality of ESSs 420 and a power command distribution equipment 410.

Referring to FIG. 4, the power supply system according to an embodiment may include the power command distribution equipment 410 and the plurality of ESSs 420. In a n embodiment, the power supply system including the power command distribution equipment 410 and the plurality of ESSs 420 may include the power supply systems including at least one photovoltaic generator and at least one load illustrated in FIGS. 1 to 3.

In the disclosure, the power command distribution equipment 410 refers to an apparatus that controls a level of input power or a level of output power of each of the plurality of ESSs 420 to the power supply system by distributing a power command to each of the plurality of ESSs 420.

In an embodiment, the power command distribution equipment 410 may be implemented as the distribution equipment 15 illustrated in FIG. 1, the distribution panel 34 illustrated in FIG. 2, or the main controller 44 illustrated in FIG. 3, or may be implemented as a computing apparatus that is connected to the distribution equipment 15 illustrated in FIG. 1, the distribution panel 34 illustrated in FIG. 2, or the main controller 44 illustrated in FIG. 3 and configured to control the level of input power or the level of output power of each of the plurality of ESSs 420.

In an embodiment, the plurality of ESSs 420 may include a plurality of ESSs connected in parallel to the power supply system. For example, the plurality of ESSs 420 may be connected in parallel to the power supply system by being each electrically connected to the power command distribution equipment 410 constituting the power supply system.

As another example, the plurality of ESSs 420 may be connected in parallel to the power supply system by being each electrically connected to a distribution panel constituting the power supply system. In this case, the power command distribution equipment 410 may control the level of input power or the level of output power of each of the plurality of ESSs 420 with respect to the power supply system by controlling at least some components (for example, a power supply circuit) of the distribution panel.

In an embodiment, the plurality of ESSs 420 may be connected in parallel to an AC area of the power supply system. In this case, each of the plurality of ESSs 420 may include a battery charged and discharged with DC power, and a power conversion module that converts DC power to AC power or converts AC power to DC power between the battery and the AC area of the power supply system.

The plurality of ESSs 420 may be connected to the power supply system to be charged or discharged and may enable efficient operation of the power supply system by storing excess power generated and supplying power to the load when the load requires the power.

In some embodiments, as the plurality of ESSs 420 are connected in parallel to the power supply system, outputs or capacities of the ESSs 420 may function complementarily, thereby improving power supply stability of the power supply system.

However, the plurality of ESSs 420 may have different state of charge (SOC) values from each other in a charging or discharging process due to various causes such as differences in manufacturers, differences in product types, addition of new ESSs, application of specific balancing algorithms, and differences in state of health (SOH) of the respective ESSs 420.

For example, the plurality of ESSs 420 may include a first ESS 421, a second ESS 422, and a third ESS 423. In this case, a first SOC value of the first ESS 421 may be X1, a second SOC value of the second ESS 422 may be X2, and a third SOC value of the third ESS 423 may be X3, and X1, X2, and X3 may have different values.

In a case where the first ESS 421 enters an over-discharge state as the first SOC value is less than a certain threshold, a maximum output of the plurality of ESSs 420 decreases by an amount of output corresponding to the first ESS 421, and thus, expected performance of the plurality of ESSs 420 may be reduced by the amount.

For example, when the plurality of ESSs 420 equally share the same power with respect to a load as in conventional technology, in a case where the first ESS 421 among the first ESS 421, the second ESS 422, and the third ESS 423 enters an over-discharge state, the expected performance of the plurality of ESSs 420 may be reduced to a ⅔ level.

Therefore, it is necessary to adjust a level of SOC imbalance in order to stably operate the power supply system including ESSs. According to an embodiment, the level of SOC imbalance may be adjusted by appropriately distributing a total power command value to each of the plurality of ESSs 420 in a power command distribution process.

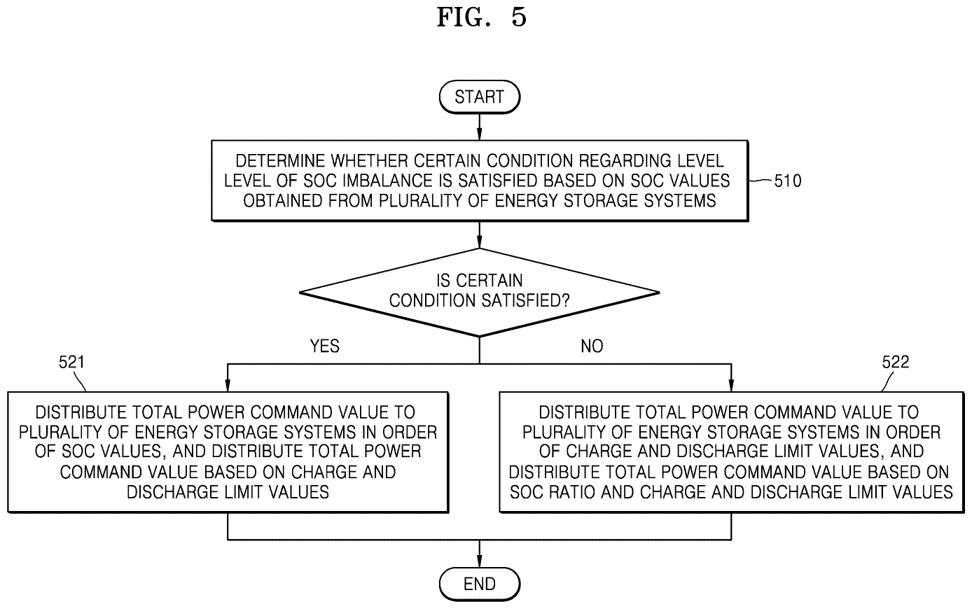

Hereinafter, a process in which the power command distribution equipment 410 distributes power commands to the plurality of ESSs 420 will be described in detail with reference to FIG. 5 and the like.

FIG. 5 is an example of an operating method of a power command distribution equipment.

Referring to FIG. 5, in operation 510, the power command distribution equipment 410 may determine whether a certain condition regarding a level of SOC imbalance is satisfied based on SOC values obtained from the plurality of ESSs 420.

In an embodiment, the power command distribution equipment 410 may obtain an SOC value corresponding to each of the plurality of ESSs 420 by performing controller area network (CAN) communication with each of the plurality of ESSs 420. In some embodiments, the power command distribution equipment 410 may further obtain charge and discharge limit values corresponding to each of the plurality of ESSs 420 by performing CAN communication with each of the plurality of ESSs 420.

In an embodiment, the power command distribution equipment 410 may determine whether the certain condition is satisfied based on SOC values corresponding to a first time point.

In an embodiment, the certain condition may include a condition that an absolute value of an SOC ratio difference for at least one pair among the plurality of ESSs 420 exceeds a preset threshold.

In an embodiment, each of the plurality of ESSs 420 may include an ESS connected in parallel to a power supply system including at least one photovoltaic generator and at least one load.

In operation 521, the power command distribution equipment 410 may distribute a total power command value to the plurality of ESSs 420 in order of SOC values in response to the certain condition being satisfied, and may distribute the total power command value based on charge and discharge limit values.

In an embodiment, the power command distribution equipment 410 may determine a distribution order of each of the plurality of ESSs 420 such that the total power command value is distributed in order of decreasing SOC values, in response to the total power command value being positive and the certain condition being satisfied, and may determine a distribution order of each of the plurality of ESSs 420 such that the total power command value is distributed in order of increasing SOC values, in response to the total power command value being negative and the certain condition being satisfied.

Thereafter, the power command distribution equipment 410 may sequentially distribute the total power command value to the plurality of ESSs 420 by distributing, to a certain ESS, from a remaining value of the total power command value, an amount of power corresponding to a minimum value among charge and discharge limit values of the certain ESS and an absolute value of the remaining value.

Moreover, in operation 522, the power command distribution equipment 410 may distribute a total power command value to the plurality of ESSs 420 in order of charge and discharge limit values in response to the certain condition not being satisfied, and may distribute the total power command value based on an SOC ratio and charge and discharge limit values.

In an embodiment, the power command distribution equipment 410 may determine a distribution order of each of the plurality of ESSs 420 such that the total power command value is distributed in order of increasing charge and discharge limit values, in response to the certain condition not being satisfied.

Thereafter, the power command distribution equipment 410 may sequentially distribute the total power command value to the plurality of ESSs 420 by distributing, to a certain ESS, from a remaining value of the total power command value, an amount of power corresponding to a minimum value among charge and discharge limit values of the certain ESS and an absolute value of a reference value corresponding to the certain ESS. In this case, the reference value corresponding to the certain ESS may be a value obtained by multiplying the remaining value of the total power command value by an SOC ratio corresponding to the certain ESS.

In an embodiment, after the total power command value is distributed, the power command distribution equipment 410 may determine whether the certain condition is satisfied based on SOC values corresponding to a second time point obtained from the plurality of ESSs 420.

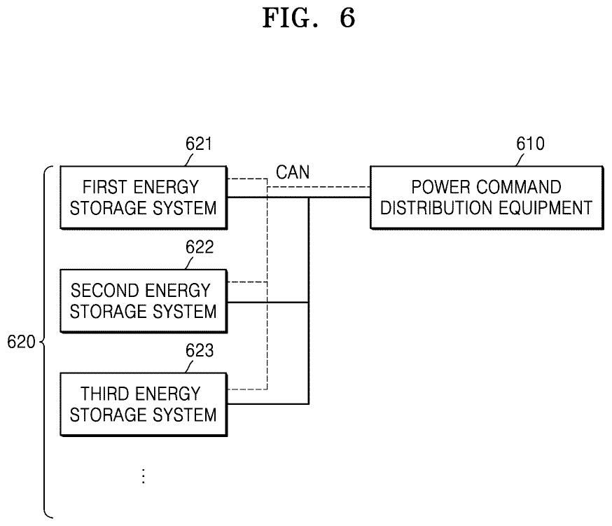

FIG. 6 is a drawing for explaining a process of obtaining data from a plurality of ESSs 620. In some embodiments, a power command distribution equipment 610 and the plurality of ESSs 620 illustrated in FIG. 6 may represent the power command distribution equipment 410 and the plurality of ESSs 420 illustrated in FIG. 4.

Referring to FIG. 6, the power command distribution equipment 610 may identify a level of SOC imbalance for the plurality of ESSs 620 based on SOC values obtained from the plurality of ESSs 620.

In an embodiment, the power command distribution equipment 610 may exchange data by communicating with each of the plurality of ESSs 620 using a network. In this case, the network may refer to a data communication network in a comprehensive sense that enables different entities to smoothly communicate with each other.

In an embodiment, the power command distribution equipment 610 may perform CAN communication with each of the plurality of ESSs 620. For example, each of the plurality of ESSs 620 may be connected to a CAN bus connected to the power command distribution equipment 610. As an example, each of a first ESS 621, a second ESS 622, and a third ESS 623 may be connected to the CAN bus connected to the power command distribution equipment 610 and may exchange various types of data with the power command distribution equipment 610 through the CAN bus.

Accordingly, power commands may be adjusted in detail by reflecting a real-time state of each ESS, thereby improving real-time performance of power command distribution and improving stability of power supply.

In an embodiment, each of the plurality of ESSs 620 may include a battery and a CAN transceiver. In this case, the CAN transceiver of each of the plurality of ESSs 620 may implement CAN communication between the plurality of ESSs 620 and the power command distribution equipment 610 by being connected to the CAN bus.

As described above with reference to FIG. 4, the plurality of ESSs 620 may be electrically connected to the power supply system through the power command distribution equipment 610, or may be electrically connected to the power supply system through another component of the power supply system distinguished from the power command distribution equipment 610. In this case, the CAN bus that connects the power command distribution equipment 610 and the plurality of ESSs 620 to each other may be implemented separately from a power line that connects the plurality of ESSs 620 to the power supply system.

In an embodiment, the power command distribution equipment 610 may obtain an SOC value corresponding to each of the plurality of ESSs 620 by performing CAN communication with each of the plurality of ESSs 620. In an embodiment, the SOC value may refer to a value representing available capacity of a battery as a ratio. In an embodiment, each of the plurality of ESSs 620 may include a battery and a BMS, and the BMS may generate and store an SOC value of the battery.

In an embodiment, the power command distribution equipment 610 may obtain a first SOC value of the first ESS 621 from the first ESS 621 by performing CAN communication with the first ESS 621. Similarly, the power command distribution equipment 610 may obtain a second SOC value of the second ESS 622 and a third SOC value of the third ESS 623 from the second ESS 622 and the third ESS 623 by performing CAN communication with the second ESS 622 and the third ESS 623, respectively.

In some embodiments, the power command distribution equipment 610 may further obtain charge and discharge limit values corresponding to each of the plurality of ESSs 620 by performing CAN communication with each of the plurality of ESSs 620. In the disclosure, the charge and discharge limit values refer to maximum power that a certain ESS may safely allow in a current state. In an embodiment, the charge and discharge limit values may include a charge limit value that is maximum charge power that a certain ESS may safely allow in a current state and a discharge limit value that is maximum discharge power that a certain ESS may safely allow in a current state.

In an embodiment, each of the plurality of ESSs 620 may include a battery and a BMS, and the BMS may generate and store charge and discharge limit values of the battery. In this case, the charge and discharge limit values may be generated according to a preset limit algorithm, and the limit algorithm may be set in consideration of manufacturer specifications, temperature of the battery, internal resistance, SOC, and/or SOH.

As an example, the limit algorithm may be set with an SOC value as a factor, and when an SOC value at a first time point is greater than an SOC value at a second time point, a discharge limit value of a certain ESS corresponding to the SOC value at the first time point may be greater than a discharge limit value corresponding to the SOC value at the second time point. In some embodiments, as an example, when a certain SOC value is less than or equal to a preset threshold (for example, 10 %), a discharge limit value of the certain ESS corresponding to the certain SOC value may be 0.

In an embodiment, the power command distribution equipment 610 may obtain first charge and discharge limit values of the first ESS 621, second charge and discharge limit values of the second ESS 622, and third charge and discharge limit values of the third ESS 623 from the first ESS 621, the second ESS 622, and the third ESS 623 by performing CAN communication with the first ESS 621, the second ESS 622, and the third ESS 623, respectively.

As described above, the power command distribution equipment 610 may identify the level of SOC imbalance for the plurality of ESSs 620 based on SOC values obtained from the plurality of ESSs 620. For example, the power command distribution equipment 610 may identify the level of SOC imbalance for the plurality of ESSs 620 by determining whether a certain condition regarding the level of SOC imbalance is satisfied.

In an embodiment, the power command distribution equipment 610 may identify the level of SOC imbalance for the plurality of ESSs 620 by determining whether the certain condition regarding the level of SOC imbalance is satisfied based on the SOC values obtained from the plurality of ESSs 620.

In an embodiment, the certain condition may include that an absolute value of an SOC ratio difference for at least one pair among the plurality of ESSs 620 exceeds a preset threshold. In this case, an SOC ratio refers to a value obtained by dividing an SOC value of the certain ESS by a total SOC value obtained by summing all SOC values of the plurality of ESSs 620.

For example, the plurality of ESSs 620 may include the first ESS 621, the second ESS 622, and the third ESS 623, and SOC values corresponding to the first, second, and third ESSs 621, 622, and 623 may be X1, X2, and X3, respectively. In this case, a first SOC ratio of the first ESS 621 may be X1/(X1+X2+X3), a second SOC ratio of the second ESS 622 may be X2/(X1+X2+X3), and a third SOC ratio of the third ESS 623 may be X3/(X1+X2+X3).

In some embodiments, an SOC ratio difference for any one pair among the plurality of ESSs 620 may be (X1−X2)/(X1+X2+X3), (X2−X3)/(X1+X2+X3), or (X3−X1)/(X1+X2+X3). The power command distribution equipment 610 may determine that the certain condition is satisfied when any one of absolute values of SOC ratio differences such as (X1−X2)/(X1+X2+X3), (X2−X3)/(X1+X2+X3), and (X3−X1)/(X1+X2+X3) exceeds a preset threshold (for example, 0.05 or 0.1).

Accordingly, even when a level of SOC imbalance for any one pair among the plurality of ESSs 620 is outside an acceptable level, the power command distribution equipment 610 may determine that the certain condition is satisfied and perform power command distribution according to a “high imbalance level,” and when all pairs among the plurality of ESSs 620 have levels of SOC imbalance not outside the acceptable level, the power command distribution equipment 610 may determine that the certain condition is not satisfied and perform power command distribution according to a “low imbalance level.”

In another embodiment, the certain condition may be configured to include that a size of variance (or standard deviation) represented by SOC values or SOC ratios of all of the plurality of ESSs 620 exceeds a preset threshold, but is not limited thereto.

The certain condition according to an embodiment may include a condition for determining whether the power command distribution equipment 610 performs power command distribution according to the “low imbalance level” or performs power command distribution according to the “high imbalance level.”

After the level of SOC imbalance for the plurality of ESSs 620 is identified by determining whether the certain condition regarding the level of SOC imbalance is satisfied as described above, the power command distribution equipment 610 may apply a power command distribution algorithm based on a result of the determination. In this case, the power command distribution algorithm refers to an algorithm for distributing a total power command value to each of the plurality of ESSs 620, and depending on which power command distribution algorithm is used, at least one of an order in which distribution is performed by allocating at least a portion of the total power command value (or a criterion for determining the order) and a magnitude of power to be allocated to the certain ESS according to the order (or a criterion for determining the magnitude of power) may be different.

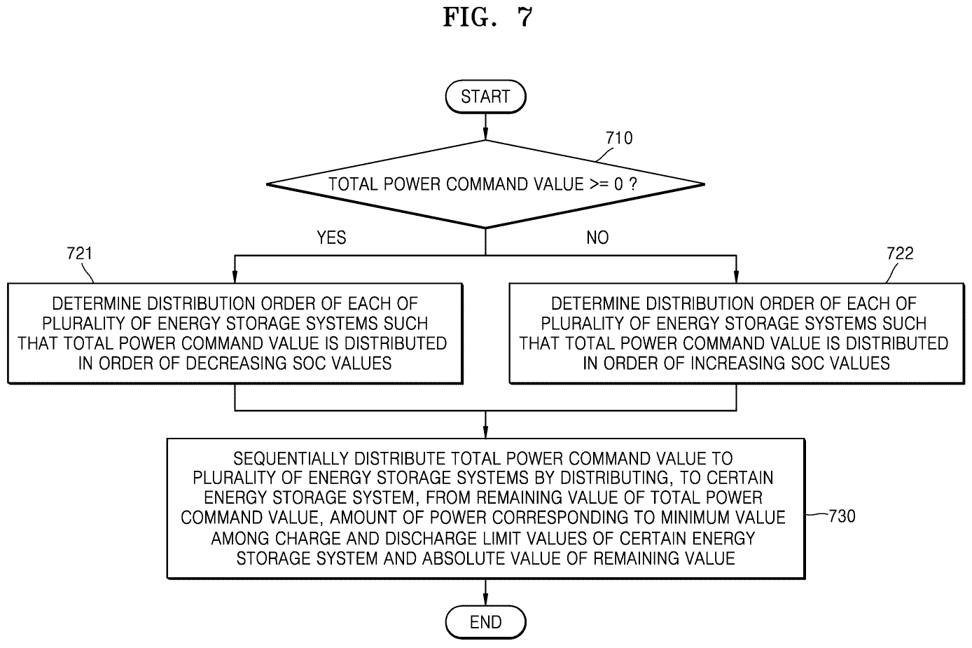

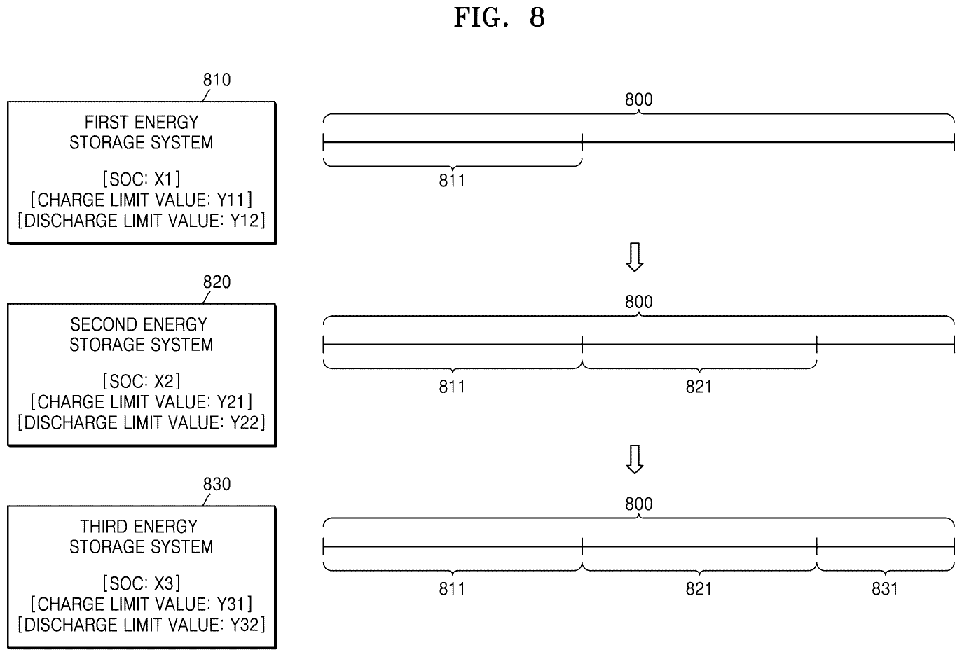

In an embodiment, the power command distribution equipment 610 may determine that the certain condition regarding the level of SOC imbalance is satisfied based on the SOC values and may determine the power command distribution algorithm as a first distribution algorithm. In this case, a process of distributing power commands by applying the first distribution algorithm will be described below with reference to FIGS. 7 to 8.

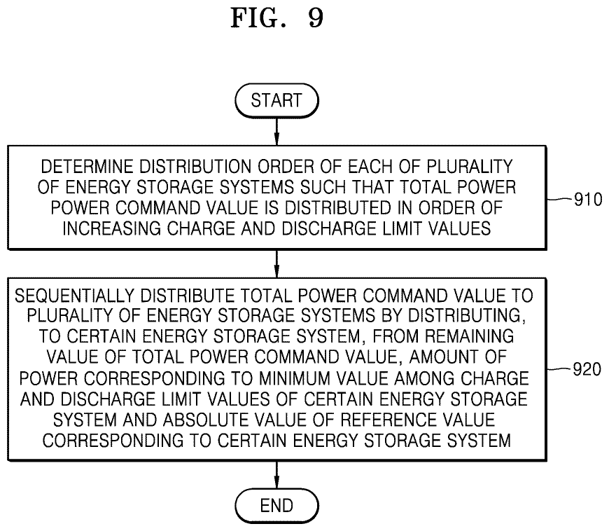

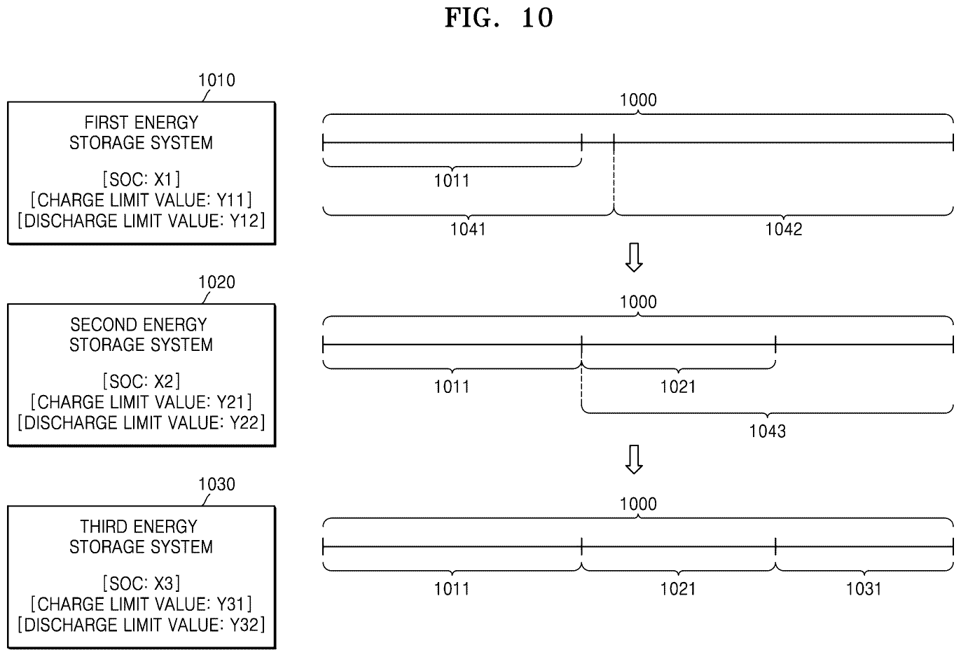

In some embodiments, in an embodiment, the power command distribution equipment 610 may determine that the certain condition regarding the level of SOC imbalance is not satisfied based on the SOC values and may determine the power command distribution algorithm as a second distribution algorithm. In this case, a process of distributing power commands by applying the second distribution algorithm will be described below with reference to FIGS. 9 to 10.

Accordingly, charging and discharging may be controlled while minimizing an SOC deviation, that is, the level of SOC imbalance, among the plurality of ESSs 620, thereby preventing performance degradation of the battery, extending the life of a system, and maintaining stable power supply.

In some embodiments, the power command distribution equipment 610 may determine a total power command value that is a purpose of distribution before determining whether the certain condition is satisfied. In an embodiment, the power command distribution equipment 610 may determine a total power command value based on data regarding power supply and power usage collected from a photovoltaic generator side and/or a load side, or may determine a total power command value based on user input from a user such as a system administrator.

As an example, the power command distribution equipment 610 may obtain data regarding power supply and power usage and may determine a total power command value corresponding to excess power generated or power lacking in supply based on the data regarding power supply and power usage. For example, when power supplied from a photovoltaic generator is 5 kW and power required by a load is 3 kW, the power command distribution equipment 610 may determine −2 kW as the total power command value.

In this case, a sign of the total power command value may represent output or input of an ESS. That is, a negative total power command value may represent how much power the plurality of ESSs 620 need to be charged with, and a positive total power command value may represent how much power the plurality of ESSs 620 need to be discharged with. Moreover, a sign according to charging or discharging may be set oppositely according to system design.

As another example, the power command distribution equipment 610 may determine a total power command value based on user input obtained from a user such as a system administrator through a user interface integrated into or connected to the power command distribution equipment 610. For example, the user input may include a user input for selecting a total power command value. In some embodiments, one of ordinary skill in the art may understand that a range of selectable total power command values may be limited due to internal limitations of the power supply system.

FIG. 7 is a drawing for explaining a process of distributing a total power command value to a plurality of ESSs when a certain condition is satisfied. Operations 710 to 730 illustrated in FIG. 7 are an example of a specific process in which operation 521 illustrated in FIG. 5 is performed, and may represent the first distribution algorithm described above with reference to FIG. 6.

That is, FIG. 7 illustrates an example of a specific process in which the power command distribution equipment 610 distributes power commands in response to a certain condition being satisfied. Specifically, the power command distribution equipment 610 may distribute a total power command value to the plurality of ESSs 620 in order of SOC values in response to the certain condition being satisfied, and may distribute the total power command value based on charge and discharge limit values.

Referring to FIG. 7, in operation 710, the power command distribution equipment 610 may determine whether a total power command value is greater than or equal to 0.

In operation 721, the power command distribution equipment 610 may determine a distribution order of each of the plurality of ESSs 620 such that the total power command value is distributed in order of decreasing SOC values, in response to the total power command value being greater than or equal to 0. In an embodiment, the power command distribution equipment 610 may determine a distribution order of each of the plurality of ESSs 620 such that the total power command value is distributed in order of decreasing SOC values, in response to the total power command value being positive.

For example, when the total power command value is greater than or equal to 0, the first ESS 621 has a greater SOC value than the second ESS 622, and the second ESS 622 has a greater SOC value than the third ESS 623, the power command distribution equipment 610 may determine the distribution order with the first ESS 621 as a first priority, the second ESS 622 as a second priority, and the third ESS 623 as a third priority.

Accordingly, when a level of SOC imbalance is high and discharging of the plurality of ESSs 620 is necessary, output power of an ESS having a high SOC value may be adjusted to a maximum or relatively high level, and the level of SOC imbalance may be reduced.

In operation 722, the power command distribution equipment 610 may determine a distribution order of each of the plurality of ESSs 620 such that the total power command value is distributed in order of increasing SOC values, in response to the total power command value being less than 0. In an embodiment, the power command distribution equipment 610 may determine a distribution order of each of the plurality of ESSs 620 such that the total power command value is distributed in order of increasing SOC values, in response to the total power command value being negative.

For example, when the total power command value is less than 0, the first ESS 621 has a greater SOC value than the second ESS 622, and the second ESS 622 has a greater SOC value than the third ESS 623, the power command distribution equipment 610 may determine the distribution order with the third ESS 623 as a first priority, the second ESS 622 as a second priority, and the first ESS 621 as a third priority.

Accordingly, when a level of SOC imbalance is high and charging of the plurality of ESSs 620 is necessary, input power of an ESS having a low SOC value may be adjusted to a maximum or relatively high level, and the level of SOC imbalance may be reduced.

In operation 730, the power command distribution equipment 610 may sequentially distribute the total power command value to the plurality of ESSs by distributing, to a certain ESS, from a remaining value of the total power command value, an amount of power corresponding to a minimum value among charge and discharge limit values of the certain ESS and an absolute value of the remaining value. In this case, the remaining value of the total power command value may represent a value obtained by subtracting an amount of power distributed to ESSs having a higher priority than the certain ESS from the total power command value.

That is, the power command distribution equipment 610 may sequentially distribute the total power command value according to the distribution order by allocating the entire remaining value of the total power command value to the certain ESS or, when that is not possible, allocating a charge limit value or a discharge limit value of the certain ESS.

Accordingly, when a level of SOC imbalance is high, output power of an ESS having a high SOC value may be adjusted to a maximum or relatively high level, input power of an ESS having a low SOC value may be adjusted to a maximum or relatively high level, and the level of SOC imbalance may be reduced.

FIG. 8 is a drawing for explaining a process of sequentially distributing a total power command value when a certain condition is satisfied. In some embodiments, a first ESS 810, a second ESS 820, and a third ESS 830 illustrated in FIG. 8 are examples of the plurality of ESSs 620 illustrated in FIG. 6. The plurality of ESSs 620 according to an embodiment may include two or more ESSs.

Referring to FIG. 8, an SOC value of the first ESS 810 is X1, a charge limit value is Y11, and a discharge limit value is Y12, an SOC value of the second ESS 820 is X2, a charge limit value is Y21, and a discharge limit value is Y22, and an SOC value of the third ESS 830 is X3, a charge limit value is Y31, and a discharge limit value is Y32.

Hereinafter, an example of a process of distributing a total power command value 800 when the total power command value 800 is positive, that is, represents discharge, X1 is greater than X2, and X2 is greater than X3 will be described in detail.

Under this premise, according to SOC values, the power command distribution equipment 610 may determine a distribution order with the first ESS 810 as a first priority, the second ESS 820 as a second priority, and the third ESS 830 as a third priority.

Thereafter, the power command distribution equipment 610 may distribute at least a portion of the total power command value 800 to the first ESS 810. In an embodiment, the power command distribution equipment 610 may compare an absolute value of the total power command value 800 with Y12 and distribute an amount of power corresponding to the minimum value to the first ESS 810.

When the absolute value of the total power command value 800 is greater than Y12, an amount of power corresponding to Y12 may be distributed to the first ESS 810. For example, a first power command 811 having a magnitude equal to Y12 may be distributed to the first ESS 810.

Thereafter, the power command distribution equipment 610 may distribute at least a portion of a remaining value of the total power command value 800 to the second ESS 820. In an embodiment, the power command distribution equipment 610 may compare an absolute value of the remaining value of the total power command value 800 with Y22 and distribute an amount of power corresponding to the minimum value to the second ESS 820. In this case, the remaining value of the total power command value 800 may represent a remainder obtained by excluding the amount of power distributed to the first ESS 810 from the total power command value 800.

When, unlike what is illustrated in FIG. 8, the absolute value of the remaining value of the total power command value 800 is less than Y22, an amount of power corresponding to the absolute value of the remaining value of the total power command value 800 may be distributed to the second ESS 820 to complete power command distribution, and distribution of the total power command value 800 may be completed without a power command for the third ESS 830.

Moreover, when the absolute value of the remaining value of the total power command value 800 is greater than Y22, an amount of power corresponding to Y22 may be distributed to the second ESS 820. For example, a second power command 821 having a magnitude equal to Y22 may be distributed to the second ESS 820.

Thereafter, the power command distribution equipment 610 may distribute at least a portion of the remaining value of the total power command value 800 to the third ESS 830. In an embodiment, the power command distribution equipment 610 may compare an absolute value of the remaining value of the total power command value 800 with Y32 and distribute an amount of power corresponding to the minimum value to the third ESS 830. In this case, the remaining value of the total power command value 800 may represent a remainder obtained by excluding the amount of power distributed to the first ESS 810 and the amount of power distributed to the second ESS 820 from the total power command value 800.

When the absolute value of the remaining value of the total power command value 800 is less than Y32, an amount of power corresponding to the absolute value of the remaining value of the total power command value 800 may be distributed to the third ESS 830. For example, a third power command 831 having a magnitude equal to the absolute value of the remaining value of the total power command value 800 may be distributed to the third ESS 830.

Thereafter, the first ESS 810 may output power according to the first power command 811, the second ESS 820 may output power according to the second power command 821, and the third ESS 830 may output power according to the third power command 831.

Accordingly, when a level of SOC imbalance is high and discharging of the plurality of ESSs 620 is performed, the power command distribution equipment 610 may reduce the level of SOC imbalance by adjusting output power of an ESS having a relatively high SOC value to a maximum or relatively high level.

Hereinafter, an example of a process of distributing a total power command value 800 when the total power command value 800 is negative, that is, represents charging, X1 is greater than X2, and X2 is greater than X3 will be described in detail.

Under this premise, according to SOC values, the power command distribution equipment 610 may determine a distribution order with the third ESS 830 as a first priority, the second ESS 820 as a second priority, and the first ESS 810 as a third priority.

Thereafter, the power command distribution equipment 610 may distribute at least a portion of the total power command value 800 to the third ESS 830. In an embodiment, the power command distribution equipment 610 may compare an absolute value of the total power command value 800 with Y31 and distribute an amount of power corresponding to the minimum value to the third ESS 830.

When the absolute value of the total power command value 800 is greater than Y31, an amount of power corresponding to Y31 may be distributed to the third ESS 830. For example, a first power command 811 having a magnitude equal to Y31 may be distributed to the third ESS 830.

Thereafter, the power command distribution equipment 610 may distribute at least a portion of the remaining value of the total power command value 800 to the second ESS 820. In an embodiment, the power command distribution equipment 610 may compare an absolute value of the remaining value of the total power command value 800 with Y21 and distribute an amount of power corresponding to the minimum value to the second ESS 820. In this case, the remaining value of the total power command value 800 may represent a remainder obtained by excluding the amount of power distributed to the third ESS 830 from the total power command value 800.

When, unlike what is illustrated in FIG. 8, the absolute value of the remaining value of the total power command value 800 is less than Y21, an amount of power corresponding to the absolute value of the remaining value of the total power command value 800 may be distributed to the second ESS 820 to complete power command distribution, and distribution of the total power command value 800 may be completed without a power command for the first ESS 810.

Moreover, when the absolute value of the remaining value of the total power command value 800 is greater than Y21, an amount of power corresponding to Y21 may be distributed to the second ESS 820. For example, a second power command 821 having a magnitude equal to Y21 may be distributed to the second ESS 820.

Thereafter, the power command distribution equipment 610 may distribute at least a portion of the remaining value of the total power command value 800 to the first ESS 810. In an embodiment, the power command distribution equipment 610 may compare an absolute value of the remaining value of the total power command value 800 with Y11 and distribute an amount of power corresponding to the minimum value to the first ESS 810. In this case, the remaining value of the total power command value 800 may represent a remainder obtained by excluding the amount of power distributed to the third ESS 830 and the amount of power distributed to the second ESS 820 from the total power command value 800.

When the absolute value of the remaining value of the total power command value 800 is less than Y11, an amount of power corresponding to the absolute value of the remaining value of the total power command value 800 may be distributed to the first ESS 810. For example, a third power command 831 having a magnitude equal to the absolute value of the remaining value of the total power command value 800 may be distributed to the first ESS 810.

Thereafter, power may be input to the third ESS 830 according to the first power command 811, to the second ESS 820 according to the second power command 821, and to the first ESS 810 according to the third power command 831.

Accordingly, when a level of SOC imbalance is high and charging of the plurality of ESSs 620 is performed, the power command distribution equipment 610 may reduce the level of SOC imbalance by adjusting input power of an ESS having a relatively low SOC value to a maximum or relatively high level.

FIG. 9 is a drawing for explaining a process of distributing a total power command value to a plurality of ESSs when a certain condition is not satisfied. Operations 910 to 920 illustrated in FIG. 9 are an example of a specific process in which operation 522 illustrated in FIG. 5 is performed, and may represent the second distribution algorithm described above with reference to FIG. 6.

That is, FIG. 9 illustrates an example of a specific process in which the power command distribution equipment 610 distributes power commands in response to a certain condition not being satisfied. Specifically, the power command distribution equipment 610 may distribute a total power command value to a plurality of ESSs in order of charge and discharge limit values in response to the certain condition not being satisfied, and may distribute the total power command value based on an SOC ratio and charge and discharge limit values.

Referring to FIG. 9, in operation 910, the power command distribution equipment 610 may determine a distribution order of each of the plurality of ESSs such that the total power command value is distributed in order of increasing charge and discharge limit values.

For example, when the total power command value is greater than or equal to 0, the first ESS 621 has a greater discharge limit value than the second ESS 622, and the second ESS 622 has a greater discharge limit value than the third ESS 623, the power command distribution equipment 610 may determine the distribution order with the third ESS 623 as a first priority, the second ESS 622 as a second priority, and the first ESS 621 as a third priority.

In some embodiments, for example, when the total power command value is less than 0, the first ESS 621 has a greater charge limit value than the second ESS 622, and the second ESS 622 has a greater charge limit value than the third ESS 623, the power command distribution equipment 610 may determine the distribution order with the third ESS 623 as a first priority, the second ESS 622 as a second priority, and the first ESS 621 as a third priority.

Accordingly, power command distribution for an ESS having small charge and discharge limit values may be performed first. That is, power command distribution may be performed first to an ESS that is likely to have power command distribution for maintaining a low level of SOC imbalance limited by charge and discharge limit values.

When a distribution order of an ESS having small charge and discharge limit values is determined as a lower priority, a remaining value of the total power command value exceeds the charge and discharge limit values at the corresponding order, and thus, a total of two or more distribution cycles according to the distribution order are required. In contrast, when power command distribution for an ESS having small charge and discharge limit values is performed first, even when the remaining value of the total power command value becomes greater than an expected value due to charge and discharge limit values of the corresponding ESS, charge and discharge limit values of lower-priority ESSs have relatively large values, and thus, the entire remaining value of the total power command value may be distributed within one distribution cycle.

Moreover, the power command distribution equipment 610 may determine a distribution order with an ESS having a large SOC value as a higher priority and an ESS having a small SOC value as a lower priority based on a pair of ESSs having the same charge and discharge limit values being identified and the total power command value being greater than or equal to 0.

In some embodiments, the power command distribution equipment 610 may determine a distribution order with an ESS having a small SOC value as a higher priority and an ESS having a large SOC value as a lower priority based on a pair of ESSs having the same charge and discharge limit values being identified and the total power command value being less than 0.

Accordingly, even when a pair of ESSs having the same charge and discharge limit values is identified, an error due to duplicate priorities may be prevented.

In operation 920, the power command distribution equipment 610 may sequentially distribute the total power command value to the plurality of ESSs by distributing, to a certain ESS, from a remaining value of the total power command value, an amount of power corresponding to a minimum value among charge and discharge limit values of the certain ESS and an absolute value of a reference value corresponding to the certain ESS. In this case, the reference value corresponding to the certain ESS may be a value obtained by multiplying the remaining value of the total power command value by an SOC ratio corresponding to the certain ESS.

That is, the power command distribution equipment 610 may sequentially distribute the total power command value according to the distribution order by allocating, to the certain ESS, the reference value obtained by multiplying the remaining value of the total power command value by the SOC ratio corresponding to the certain ESS or, when that is not possible, allocating a charge limit value or a discharge limit value of the certain ESS.

Accordingly, when a level of SOC imbalance is low, the plurality of ESSs 620 may be charged or discharged while maintaining SOC ratios, and the low level of SOC imbalance may be maintained. In some embodiments, power command distribution for an ESS that is likely to have power command distribution for maintaining a low level of SOC imbalance limited by charge and discharge limit values is performed first, and thus, power commands may be distributed rapidly and efficiently.

In some embodiments, even when a level of SOC imbalance is low, power command distribution approximated based on SOC ratios is performed, and thus, SOC differences may be expected to gradually decrease.

FIG. 10 is a drawing for explaining a process of sequentially distributing a total power command value when a certain condition is not satisfied. In some embodiments, a first ESS 1010, a second ESS 1020, and a third ESS 1030 illustrated in FIG. 10 are examples of the plurality of ESSs 620 illustrated in FIG. 6. The plurality of ESSs 620 according to an embodiment may include two or more ESSs.

Referring to FIG. 10, an SOC value of the first ESS 1010 is X1, a charge limit value is Y11, and a discharge limit value is Y12, an SOC value of the second ESS 1020 is X2, a charge limit value is Y21, and a discharge limit value is Y22, and an SOC value of the third ESS 1030 is X3, a charge limit value is Y31, and a discharge limit value is Y32.

Hereinafter, an example of a process of distributing a total power command value 1000 when the total power command value 1000 is positive, that is, represents discharge, Y12 is greater than Y22, and Y22 is greater than Y32 will be described in detail.

Under this premise, according to magnitudes of discharge limit values, the power command distribution equipment 610 may determine a distribution order with the third ESS 1030 as a first priority, the second ESS 1020 as a second priority, and the first ESS 1010 as a third priority.

Thereafter, the power command distribution equipment 610 may distribute at least a portion of the total power command value 1000 to the third ESS 1030. In an embodiment, the power command distribution equipment 610 may compare a reference value obtained by multiplying an absolute value of the total power command value 1000 by an SOC ratio corresponding to the third ESS 1030, that is, a reference value obtained by multiplying an absolute value of the total power command value 1000 by X3/(X1+X2+X3), with Y32 and distribute an amount of power corresponding to the minimum value to the third ESS 1030.

In this case, an expected value to be primarily distributed to the third ESS 1030 in proportion to an SOC ratio is a value obtained by multiplying the absolute value of the total power command value 1000 by X3/(X1+X2+X3), and may be understood as an expected distribution value 1041 illustrated in FIG. 10. In this example, the expected distribution value 1041 has the same value as a reference value of the third ESS 1030. In some embodiments, a value obtained by subtracting the expected distribution value 1041 from a remaining value of the total power command value 1000 may be understood as an expected remaining value 1042.

When discharge limit values of all ESSs are each greater than respective expected distribution values thereof, the total power command value 1000 may be distributed to all the ESSs in proportion to SOC ratios, thereby maintaining a low level of SOC imbalance.

However, when the reference value of the third ESS 1030 is greater than Y32, an amount of power corresponding to Y32 may be distributed to the third ESS 1030. For example, a first power command 1011 having a magnitude equal to Y32 may be distributed to the third ESS 1030.

As described above, when the reference value of the third ESS 1030 is greater than Y32, an actual remaining value 1043 becomes greater than the expected remaining value 1042 after the first power command 1011 is distributed. When an ESS having a small discharge limit value has a lower distribution priority than an ESS having a large discharge limit value, a situation, in which the actual remaining value 1043 is unable to be distributed to all lower-priority ESSs, may occur. In order to minimize the possibility of occurrence of such a situation, the distribution order may be determined according to magnitudes of charge and discharge limit values.

Thereafter, the power command distribution equipment 610 may distribute at least a portion of the remaining value of the total power command value 1000 to the second ESS 1020. In an embodiment, the power command distribution equipment 610 may compare a reference value obtained by multiplying an absolute value of the remaining value of the total power command value 1000 by an SOC ratio corresponding to the second ESS 1020 with Y22 and distribute an amount of power corresponding to the minimum value to the second ESS 1020.

In this case, an SOC ratio corresponding to a certain ESS may refer to an SOC ratio calculated excluding higher-priority ESSs. Because the actual remaining value 1043 may have a greater value than the expected remaining value 1042 according to a discharge limit value of a higher-priority ESS, such calculation may be performed to appropriately distribute the actual remaining value 1043 among remaining ESSs excluding ESSs for which distribution has been completed.

That is, the power command distribution equipment 610 may compare a value obtained by multiplying an absolute value of the remaining value of the total power command value 1000 by X2/(X1+X2) with Y22 and distribute an amount of power corresponding to the minimum value to the second ESS 1020. In this case, the remaining value of the total power command value 1000 may represent a remainder obtained by excluding the amount of power distributed to the third ESS 1030 from the total power command value 1000.

For example, a second power command 1021 having a magnitude equal to Y22 or an absolute value of a reference value corresponding to the second ESS 1020 may be distributed to the second ESS 1020.

Thereafter, the power command distribution equipment 610 may distribute the remaining value of the total power command value 1000 to the first ESS 1010. In this case, the remaining value of the total power command value 1000 may represent a remainder obtained by excluding the amount of power distributed to the third ESS 1030 and the amount of power distributed to the second ESS 1020 from the total power command value 1000.

For example, a third power command 1031 having a magnitude equal to the remaining value of the total power command value 1000 may be distributed to the first ESS 1010.

Thereafter, the third ESS 1030 may output power according to the first power command 1011, the second ESS 1020 may output power according to the second power command 1021, and the first ESS 1010 may output power according to the third power command 1031.

Accordingly, when a level of SOC imbalance is small and discharging of the plurality of ESSs 620 is performed, the plurality of ESSs 620 may be discharged while maintaining SOC ratios, and the low level of SOC imbalance may be maintained. In some embodiments, power command distribution for an ESS that is likely to have power command distribution for maintaining a low level of SOC imbalance limited by a discharge limit value is performed first, and thus, power commands may be distributed rapidly and efficiently.

Hereinafter, an example of a process of distributing a total power command value 1000 when the total power command value 1000 is negative, that is, represents charging, Y11 is greater than Y21, and Y21 is greater than Y31 will be described in detail.

Under this premise, according to magnitudes of charge limit values, the power command distribution equipment 610 may determine a distribution order with the third ESS 1030 as a first priority, the second ESS 1020 as a second priority, and the first ESS 1010 as a third priority.

Thereafter, the power command distribution equipment 610 may distribute at least a portion of the total power command value 1000 to the third ESS 1030. In an embodiment, the power command distribution equipment 610 may compare a reference value obtained by multiplying an absolute value of the total power command value 1000 by an SOC ratio corresponding to the third ESS 1030, that is, a reference value obtained by multiplying an absolute value of the total power command value 1000 by X3/(X1+X2+X3), with Y31 and distribute an amount of power corresponding to the minimum value to the third ESS 1030.

Thereafter, the power command distribution equipment 610 may distribute at least a portion of the remaining value of the total power command value 1000 to the second ESS 1020. In an embodiment, the power command distribution equipment 610 may compare a reference value obtained by multiplying an absolute value of the remaining value of the total power command value 1000 by an SOC ratio corresponding to the second ESS 1020 with Y21 and distribute an amount of power corresponding to the minimum value to the second ESS 1020.

In this case, an SOC ratio corresponding to a certain ESS may refer to an SOC ratio calculated excluding higher-priority ESSs. Because the actual remaining value 1043 may have a greater value than the expected remaining value 1042 according to a discharge limit value of a higher-priority ESS, such calculation may be performed to appropriately distribute the actual remaining value 1043 among remaining ESSs excluding ESSs for which distribution has been completed.

That is, the power command distribution equipment 610 may compare a value obtained by multiplying an absolute value of the remaining value of the total power command value 1000 by X2/(X1+X2) with Y21 and distribute an amount of power corresponding to the minimum value to the second ESS 1020. In this case, the remaining value of the total power command value 1000 may represent a remainder obtained by excluding the amount of power distributed to the third ESS 1030 from the total power command value 1000.

For example, a second power command 1021 having a magnitude equal to Y22 or an absolute value of a reference value corresponding to the second ESS 1020 may be distributed to the second ESS 1020.

Thereafter, the power command distribution equipment 610 may distribute the remaining value of the total power command value 1000 to the first ESS 1010. In this case, the remaining value of the total power command value 1000 may represent a remainder obtained by excluding the amount of power distributed to the third ESS 1030 and the amount of power distributed to the second ESS 1020 from the total power command value 1000.

For example, a third power command 1031 having a magnitude equal to the remaining value of the total power command value 1000 may be distributed to the first ESS 1010.

Thereafter, power may be input to the third ESS 1030 according to the first power command 1011, to the second ESS 1020 according to the second power command 1021, and to the first ESS 1010 according to the third power command 1031.

Accordingly, when a level of SOC imbalance is small and charging of the plurality of ESSs 620 is performed, the plurality of ESSs 620 may be charged while maintaining SOC ratios, and the low level of SOC imbalance may be maintained. In some embodiments, power command distribution for an ESS that is likely to have power command distribution for maintaining a low level of SOC imbalance limited by a charge limit value is performed first, and thus, power commands may be distributed rapidly and efficiently.

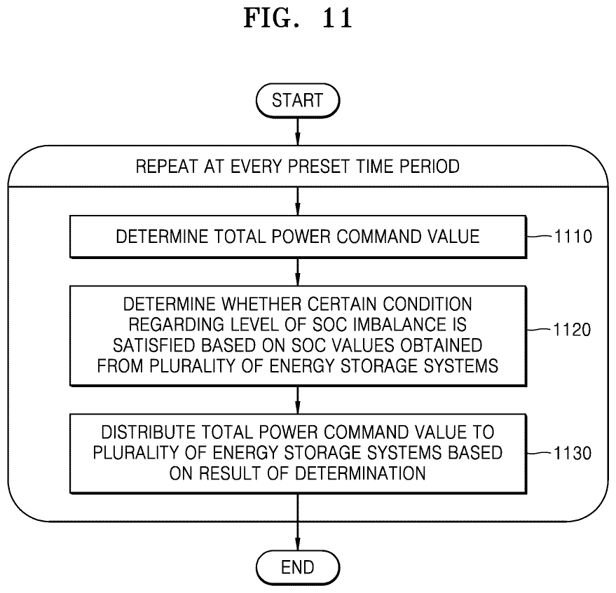

FIG. 11 is a drawing for explaining a process of repeatedly distributing a total power command value to a plurality of ESSs at every preset time period.

Referring to FIG. 11, in operation 1110, the power command distribution equipment 610 may determine a total power command value. In this case, the total power command value may be a value corresponding to a specific time point. In an embodiment, a power command may indicate instantaneous input power or instantaneous output power, and the total power command value may vary in real time according to internal factors of a power supply system or user input such as from an administrator.

That is, the power command distribution equipment 610 may determine a total power command value corresponding to a first time point as a specific time point.

In some embodiments, a process of determining a total power command value in operation 1110 may be performed identically to the process of determining a total power command value described above with reference to FIG. 6.

In operation 1120, the power command distribution equipment 610 may determine whether a certain condition regarding a level of SOC imbalance is satisfied based on SOC values obtained from the plurality of ESSs.

For example, the power command distribution equipment 610 may determine whether a preset certain condition regarding the level of SOC imbalance is satisfied based on SOC values corresponding to a first time point.

In this case, a process of determining whether a preset certain condition regarding the level of SOC imbalance is satisfied based on SOC values may be performed identically to the process of determining whether a preset certain condition regarding the level of SOC imbalance is satisfied described above with reference to FIG. 6.

In operation 1130, the power command distribution equipment 610 may distribute the total power command value to the plurality of ESSs based on a result of the determination.

In an embodiment, the power command distribution equipment 610 may repeatedly perform operations 1110 to 1130 at every preset time period. For example, the preset time period may be set in a range from hundreds of milliseconds (ms) to several seconds (s), but may be set in a shorter range when more precise real-time control is necessary, and may be set in a longer range when a response to large-scale load pattern changes is necessary from a macroscopic operation perspective.

In an embodiment, operations 1110 to 1130 may be performed again for a second time point having a difference equal to a preset time period from the first time point after being performed for the first time point. For example, after the total power command value is distributed, the power command distribution equipment 610 may determine whether a certain condition is satisfied based on SOC values corresponding to a second time point obtained from the plurality of ESSs.

Accordingly, the power command distribution equipment 610 may respond flexibly and stably to sudden changes occurring on a photovoltaic generator side and/or a load side and may change a distribution algorithm from one of a first distribution algorithm and a second distribution algorithm to another in response to a level of SOC imbalance becoming lower or higher during a charging and discharging process.

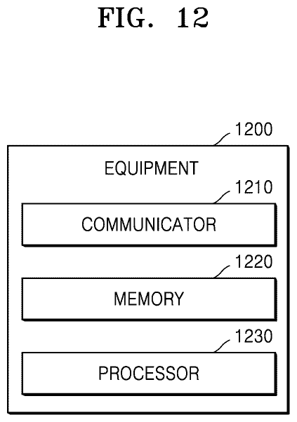

FIG. 12 is a block diagram of a power command distribution equipment. An equipment 1200 illustrated in FIG. 12 may represent the power command distribution equipment 410 illustrated in FIG. 4.

Referring to FIG. 12, the equipment 1200 may include a communicator 1210, a memory 1220, and a processor 1230. Only components related to embodiments are illustrated in the equipment 1200 of FIG. 12. Therefore, one of ordinary skill in the art may understand that other general-purpose components may be further included in the equipment 1200 in addition to the components illustrated in FIG. 12.

The communicator 1210 may include at least one component that enables the equipment 1200 to perform wired/wireless communication with at least one other apparatus constituting a power supply system (for example, the power supply system 10 illustrated in FIG. 1) and/or an apparatus outside the power supply system. For example, the communicator 1210 may include a wired communicator for implementing Ethernet, serial communication, or optical communication and/or a wireless communicator for implementing wireless fidelity (Wi-Fi), Bluetooth, or cellular network-based communication.

The memory 1220 is hardware that stores various types of data processed in the equipment 1200 and may store programs for various operations, processing, and control of the processor 1230. In some embodiments, the memory 1220 may store various types of data necessary for the processor 1230 to perform calculations by executing the programs.

The memory 1220 may include random access memory (RAM) such as dynamic random access memory (DRAM) and static random access memory (SRAM), read-only memory (ROM), electrically erasable programmable read-only memory (EEPROM), compact disk read-only memory (CD-ROM), Blu-ray or other optical disk storage, hard disk drive (HDD), solid state drive (SSD), or flash memory.

The processor 1230 controls all operations of the equipment 1200. For example, the processor 1230 may generally control the communicator 1210, the memory 1220, and the like by executing the programs stored in the memory 1220. The processor 1230 may control operations of the equipment 1200 by executing the programs stored in the memory 1220.

The processor 1230 may control at least some of the operations of the equipment 1200 described above with reference to FIGS. 1 to 11. For example, the processor 1230 may determine whether a certain condition regarding a level of SOC imbalance is satisfied based on SOC values obtained from a plurality of ESSs, and in response to the certain condition being satisfied, distribute a total power command value to the plurality of ESSs in order of SOC values, and distribute the total power command value based on charge and discharge limit values, and in response to the certain condition not being satisfied, distribute a total power command value to the plurality of ESSs in order of charge and discharge limit values, and distribute the total power command value based on an SOC ratio and charge and discharge limit values.

Moreover, specific examples of operations of the processor 1230 are the same as those described above with reference to FIGS. 1 to 11. Therefore, detailed descriptions of operations of the processor 1230 are omitted hereinafter.

The processor 1230 may be implemented using at least one of an ASIC, a DSP, a digital signal processing device (DSPD), a PLD, a FPGA, a controller, a micro-controller, a microprocessor, and an electrical unit for performing other functions.

In addition, embodiments according to the disclosure may be implemented in a form of a computer program which may be executed on a computer through various components, and the computer program may be recorded on a computer-readable medium. In this regard, the computer-readable medium may include a magnetic medium such as a hard disk, a floppy disk, or a magnetic tape, an optical recording medium such as CD-ROM or digital video disk (DVD), a magneto-optical medium such as a floptical disk, or a hardware apparatus specially configured to store and execute program instructions, such as ROM, RAM, or flash memory, but is not limited thereto.

In addition, the computer program may be specially designed and configured for the disclosure or may be known to and available to those of ordinary skill in the field of computer software. Examples of the computer program may include not only machine code, such as that produced by a compiler, but also high-level language code which may be executed by a computer using an interpreter or the like.

According to the technical solutions of the disclosure described above, SOC imbalance among ESSs may be effectively reduced by distributing power commands based on SOC values and charge and discharge limit values obtained from a plurality of ESSs.

In addition, according to technical solutions of the disclosure, by applying different distribution algorithms according to a level of SOC imbalance, each ESS may perform optimal charging and discharging within a safe range.

Effects according to embodiments are not limited to the effects mentioned above, and other effects not mentioned will be clearly understood by those of ordinary skill in the art from the description of the specification.

According to an embodiment, the method according to various embodiments of the disclosure may be provided as a part of a computer program product. The computer program product may be traded as a product between a seller and a buyer. The computer program product may be distributed in a form of a machine-readable storage medium (e.g., CD-ROM), or may be distributed online (e.g., downloaded or uploaded) through an application store (e.g., Play Store™) or directly between two user apparatuses. In the case of online distribution, at least a part of the computer program product may be at least temporarily stored or temporarily created in a machine-readable storage medium, such as a memory of a manufacturer's server, an application store's server, or a relay server.

Unless explicitly stating the order of operations constituting the method according to the disclosure or stating otherwise, the operations may be performed in an appropriate order. The disclosure is not necessarily limited to the order in which the operations are described. The use of all examples or exemplary terms (for example, etc.) in the disclosure is merely to explain the disclosure in detail, and the scope of the disclosure is not limited by the examples or exemplary terms unless limited by the claims. Also, those of ordinary skill in the art will appreciate that various modifications, combinations, and changes may be configured according to design conditions and factors within the scope of the appended claims or equivalents thereof.

Therefore, the spirit of the disclosure should not be limited to the embodiments described above, and all ranges that are equivalent to or equivalently changed from the following claims as well as these claims are within the scope of the spirit of the disclosure.

What is claimed is:

1. A method of distributing power commands, the method comprising:
determining whether a certain condition regarding a level of state of charge (SOC) imbalance is satisfied based on SOC values obtained from a plurality of energy storage systems; and
in response to the certain condition being satisfied, distributing a total power command value to the plurality of energy storage systems in order of SOC values, and distributing the total power command value based on charge and discharge limit values, and
in response to the certain condition not being satisfied, distributing the total power command value to the plurality of energy storage systems in order of charge and discharge limit values, and distributing the total power command value based on an SOC ratio and charge and discharge limit values.

2. The method of claim 1, wherein the distributing comprises,
in response to the total power command value being positive and the certain condition being satisfied, determining a distribution order of each of the plurality of energy storage systems such that the total power command value is distributed in order of decreasing SOC values, and
in response to the total power command value being negative and the certain condition being satisfied, determining the distribution order of each of the plurality of energy storage systems such that the total power command value is distributed in order of increasing SOC values.

3. The method of claim 1, wherein the distributing comprises, in response to the certain condition being satisfied, sequentially distributing the total power command value to the plurality of energy storage systems by distributing, to a certain energy storage system, from a remaining value of the total power command value, an amount of power corresponding to a minimum value among charge and discharge limit values of the certain energy storage system and an absolute value of the remaining value.

4. The method of claim 1, wherein the distributing comprises, in response to the certain condition not being satisfied, determining a distribution order of each of the plurality of energy storage systems such that the total power command value is distributed in order of increasing charge and discharge limit values.

5. The method of claim 1, wherein the distributing comprises, in response to the certain condition not being satisfied, sequentially distributing the total power command value to the plurality of energy storage systems by distributing, to a certain energy storage system, from a remaining value of the total power command value, an amount of power corresponding to a minimum value among charge and discharge limit values of the certain energy storage system and an absolute value of a reference value corresponding to the certain energy storage system,
wherein the reference value corresponding to the certain energy storage system is a value obtained by multiplying a remaining value of the total power command value by an SOC ratio corresponding to the certain energy storage system.

6. The method of claim 1, wherein the determining comprises obtaining an SOC value and charge and discharge limit values corresponding to each of the plurality of energy storage systems, by performing controller area network (CAN) communication with each of the plurality of energy storage systems.

7. The method of claim 1, wherein the determining comprises determining whether the certain condition is satisfied based on the SOC values corresponding to a first time point, and
the distributing comprises, after the total power command value is distributed, determining whether the certain condition is satisfied based on the SOC values corresponding to a second time point obtained from the plurality of energy storage systems.

8. The method of claim 1, wherein the certain condition includes that an absolute value of an SOC ratio difference for at least one pair among the plurality of energy storage systems exceeds a preset threshold.

9. The method of claim 1, wherein each of the plurality of energy storage systems includes an energy storage system connected in parallel to a power supply system including at least one photovoltaic generator and at least one load.

10. An apparatus for distributing power commands, the apparatus comprising:
a memory storing at least one program; and
a processor operating by executing the at least one program,
wherein the processor is configured to:
determine whether a certain condition regarding a level of state of charge (SOC) imbalance is satisfied based on SOC values obtained from a plurality of energy storage systems; and
in response to the certain condition being satisfied, distribute a total power command value to the plurality of energy storage systems in order of SOC values, and distribute the total power command value based on charge and discharge limit values, and
in response to the certain condition not being satisfied, distribute the total power command value to the plurality of energy storage systems in order of charge and discharge limit values, and distribute the total power command value based on an SOC ratio and charge and discharge limit values.

11. The apparatus of claim 10, wherein the distributing comprises,
in response to the total power command value being positive and the certain condition being satisfied, determining a distribution order of each of the plurality of energy storage systems such that the total power command value is distributed in order of decreasing SOC values, and
in response to the total power command value being negative and the certain condition being satisfied, determining the distribution order of each of the plurality of energy storage systems such that the total power command value is distributed in order of increasing SOC values.

12. The apparatus of claim 10, wherein the distributing comprises, in response to the certain condition being satisfied, sequentially distributing the total power command value to the plurality of energy storage systems by distributing, to a certain energy storage system, from a remaining value of the total power command value, an amount of power corresponding to a minimum value among charge and discharge limit values of the certain energy storage system and an absolute value of the remaining value.

13. The apparatus of claim 10, wherein the distributing comprises, in response to the certain condition not being satisfied, determining a distribution order of each of the plurality of energy storage systems such that the total power command value is distributed in order of increasing charge and discharge limit values.

14. The apparatus of claim 10, wherein the distributing comprises, in response to the certain condition not being satisfied, sequentially distributing the total power command value to the plurality of energy storage systems by distributing, to a certain energy storage system, from a remaining value of the total power command value, an amount of power corresponding to a minimum value among charge and discharge limit values of the certain energy storage system and an absolute value of a reference value corresponding to the certain energy storage system,
wherein the reference value corresponding to the certain energy storage system is a value obtained by multiplying a remaining value of the total power command value by an SOC ratio corresponding to the certain energy storage system.

15. The apparatus of claim 10, wherein the determining comprises obtaining an SOC value and charge and discharge limit values corresponding to each of the plurality of energy storage systems, by performing controller area network (CAN) communication with each of the plurality of energy storage systems.

16. The apparatus of claim 10, wherein the determining comprises determining whether the certain condition is satisfied based on the SOC values corresponding to a first time point, and
the distributing comprises, after the total power command value is distributed, determining whether the certain condition is satisfied based on the SOC values corresponding to a second time point obtained from the plurality of energy storage systems.

17. The apparatus of claim 10, wherein the certain condition includes that an absolute value of an SOC ratio difference for at least one pair among the plurality of energy storage systems exceeds a preset threshold.

18. The apparatus of claim 10, wherein each of the plurality of energy storage systems includes an energy storage system connected in parallel to a power supply system including at least one photovoltaic generator and at least one load.

19. A computer-readable recording medium having recorded thereon a program for causing a computer to execute the method of claim 1.
